(19) United States
(12) Patent Application Publication
(10) Pub. No.: US 2006/0141151 A1
(43) Pub. Date: Jun. 29, 2006

(54) Device and method for making structured surfaces in pipes to reduce the aerodynamic drag

(76) Inventors: Sebastien Duval, Evron (FR); Yves Charron, Longpont Sur Orge (FR); Nicolas Gautreau, Montesson (FR)

Correspondence Address: ANTONELLI, TERRY, STOUT & KRAUS, LLP, 1300 NORTH SEVENTEENTH STREET, SUITE 1800, ARLINGTON, VA, 22209-3873, US

(21) Appl. No.: 11/300,493

(22) Filed: Dec. 15, 2005

(30) Foreign Application Priority Data
Dec. 23, 2004 (FR) 04/13.803

(51) Int. Cl. B05D 7/22

(52) U.S. Cl. 427/238; 264/36.17; 138/98

(57) ABSTRACT

The invention relates to a method for making structured surfaces within pipes (1) lined with a coating and wherein fluids such as gas, hydrocarbons or water circulate.

The invention consists in irreversibly deforming, during baking and/or drying, the coating internally applied by impression, via expandable means (16), for example a rubber bladder whose outer surface bears the structurations.

### FIELD OF THE INVENTION

The present invention relates to a method and to a device for making structured surfaces within pipes so as to limit pressure drops due to the circulation of a fluid within these pipes.

### BACKGROUND OF THE INVENTION

The first work on drag reduction by means of smooth paint dates back to the mid-20^{th} century. In the case of gas-carrying pipelines, the Tennessee transport company has clearly shown the contribution of an inner paint by determining flow rate gains of the order of 10% in relation to a weakly clogged pipe, and of 6% in relation to a pipe whose wall has been cleaned.

Since the mid-20^{th} century, the use of drag-reducing agents allows considerable flow rate gains, for example of the order of 40% to 50%. These drag-reducing agents are generally polymers of high molecular mass whose function is to stabilize the turbulent underlayer. In the case of gas as well as water and oil-carrying pipes, it is not acceptable to pollute the environment by polymer molecules and the use of such additives is therefore not conceivable.

Furthermore, it is also well known that walls comprising structured surfaces allow substantial flow rate gains. The drag reduction effect is generally attributed to a turbulent structure control in the laminar layer and the turbulent underlayer.

However, there are relatively few structured surface applications. The most famous one is the use of films stuck to the boat Stars and Stripes during the America's Cup. New applications come into being for diving suits (U.S. Pat. No. 5,380,578) for which a drag reduction is observed.

In fact, friction factor reductions up to 10%, i.e. about 5% as regards the flow rate, have been demonstrated.

These drag reductions have many advantages in the sphere of fluid transportation:
possible reduction of the number of compression stations, or of the power thereof, or even use of pipes of smaller diameter (drop in investment);
energy consumption reduction (operating cost reduction) and therefore CO₂ emissions reduction.

There are different methods for making structured surfaces.

Patent U.S. Pat. No. 6,190,594 discloses the method for making structured surfaces by passing a polymer film through rolling mills. The same technology is described in patent U.S. Pat. No. 6,676,869 for carrying out an impression operation on a substrate.

Patent WO-98/08,677 describes a method for making structured surfaces on films comprising an adhesive side. This invention allows to position and to change the structured film if need be. However, these technologies are not applicable to the case of gas, oil and even water-carrying pipes because the resistance over time of these films is not guaranteed and no replacement is acceptable for obvious economic reasons. Furthermore, in the event of separation, there is a risk of a considerable pressure drop increase. Moreover, the pipes can undergo high pressure variations, which has the effect of unsticking the films. Also, the pipes are subjected to passage of the scraper or of the rabbit, instrumented for corrosion detection, which are likely to tear off the film.

It thus appears that self-adhesive films cannot be installed in fluid-carrying pipes for one or more of the following reasons:
chemical and physical inertia of the films towards fluids,
adhesion maintenance over time,
faultless application difficulty, any application defect causing loss of the advantage provided by the structured surfaces by generating a macroscopic roughness.

Furthermore, document FR-2,836,649 describes a method of knurling within a pipe provided with a coating or paint. This technique however requires a specific equipment.

### SUMMARY OF THE INVENTION

The present invention relates to a method for making structured surfaces on the inner wall of a pipe provided with a coating during baking and/or drying, wherein expandable means comprising structurations on the outer surface thereof are arranged inside the pipe, the expandable means are expanded so as to impress said structurations on the coated inner wall, baking and/or drying of the thus irreversibly deformed coating are finalized.

The expandable means can comprise a rubber bladder, the structurations being either made directly on the casing of said bladder or on a film placed on the bladder.

The expandable means can include a ring-shaped part so as to press the outer surface of the expandable means on the coating, and said part can be moved longitudinally over the length of the tube.

The expandable means can comprise a bladder having at least a double casing, the first casing being pressurized as it is fed into the pipe, the second one comprising the structurations on the outer surface thereof being pressurized from one of its ends to obtain even application from this end.

The annular space of the second casing can be reduced using an intermediate bladder casing that is pressurized after setting in the tube and before pressurization of said second casing.

The expandable means can comprise a bladder with a wall of increasing thickness between the two ends, and contacting for impressing can be obtained as a result of an internal pressure increase as a function of time.

The expandable means can comprise a bladder with a constant-thickness wall comprising a preferred deformation zone that is first contacted for impressing, as a result of an internal pressure increase as a function of time. Their shape can be that of a double cone assembled at the bases thereof.

The expandable means can comprise a set of bladders arranged longitudinally along the axis of the tube, and said bladders can be pressurized successively one after the other.

A bladder can be deflated only after inflation of the next one.

The invention also relates to a device for making structured surfaces on the inner wall of a pipe lined with a coating during baking and/or drying, which comprises expandable means including on the outer surface thereof structurations and means for expanding said expandable means so as to impress said structurations on the coated inner wall.

### BRIEF DESCRIPTION OF THE FIGURES

Other features and advantages of the present invention will be clear from reading the description hereafter of embodiments given by way of non limitative examples, with reference to the accompanying figures wherein:

FIG. 1 diagrammatically shows an embodiment of the device according to the invention,

FIG. 2 shows a variant of the device according to the invention,

FIG. 3 describes another variant,

FIGS. 4 and 5 describe other variants.

### DETAILED DESCRIPTION

The principle of the invention consists in irreversibly deforming a paint, during baking and/or drying, sprayed onto the inner wall of a pipe so as to create a structured surface, by means of a rubber bladder or more generally of expandable means set in the pipe. The impression structures are achieved either directly on the outer skin of said bladder or on a film made integral with the bladder, by sticking for example.

The material of the film has to be elastically deformable and must no adhere to the paint. Materials of fluorine elastomer thermoplastics type and silicones are perfectly suitable. In the case of films stuck onto bladders, the forms to be impressed must have dimensions that take account of the deformations generated by inflating the bladder. The bladder can be made from any elastomer such as rubber.

Structured surfaces on films can be made either:
by passage of a polymer film through a rolling mill as described in patent WO-98/08,677, one of the cylinders having structured surfaces,
by mechanical or optical engraving of a polymer film, such as laser, knurling, . . .

The advantage afforded by the present invention is that it allows to impress structures on a polymer film whose chemical inertia was tested by the pipe user. The structures just have to be impressed on a paint qualified for the application.

Using a bladder allows to adapt the deformations of the pipe which may be of the order of one millimeter whereas the patterns to be impressed are of the order of 10 to 100 μm.

The bladder entering the pipe in case of application in a factory allows to obtain a structured surface over the entire surface of the pipe in a short time interval, unlike other methods which require a longer and therefore much more expensive machining stage.

In the particular case of gas or oil-carrying pipes, the chemical inertia required by the operation over several ten-day periods considerably restricts the selection of polymers. Very few polymers are qualified for such applications, mainly polymers based on epoxide, phenolic epoxy or novolak epoxy cross-linked by amines or polyamines.

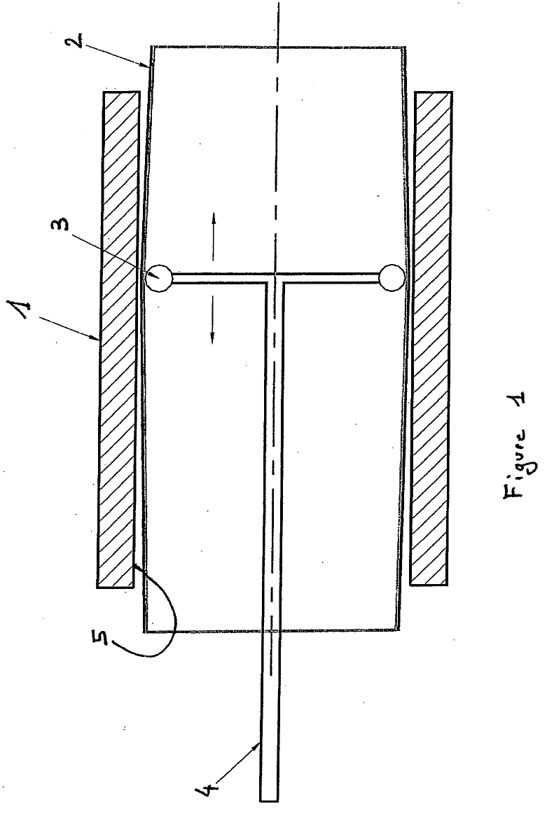

FIG. 1 shows a device for impressing structured surfaces on inner surface 5 of a tubular element 1, said surface having been covered with a coat of paint in such a state that its deformation by impression is possible.

The impression means comprise a bladder 2, i.e. a cylindrical volume whose casing is deformable. The cylindrical casing comprises the structured surfaces. Once set in tube 1, bladder 2 is subjected to expansion so that its casing is pressed onto the paint coat so as to obtain the structured surfaces. FIG. 1 diagrammatically shows expansion means 3 carried by a shaft 4 whose longitudinal displacement along the principal axis of the tube allows the wall of the bladder to be pressed against the total length of the tube. Expansion means 3 can be a toric elastic assembly so that the most regular pressure possible can be applied over an inner circumference of the pipe. This assembly can be a ring-shaped chamber, pressurized or made of a flexible material, that is shifted by sliding along the inner surface of the bladder. It is also possible to use a set of pads or wheels distributed on a circumference and comprising means for radial application of a pressure force on the bladder, either mechanical or pneumatic. These means are not detailed here because they are understandable to the person skilled in the art.

Once expanded, the expansion means are displaced over the total length of the tube.

Bladder 2 therefore has a length corresponding to the length of the tubular element. To set it in the tube, its outside diameter has to be substantially smaller than the inside diameter of the tube once coated with the paint. To provide or complete rigidity of the bladder, the latter can be sealed and pressurized.

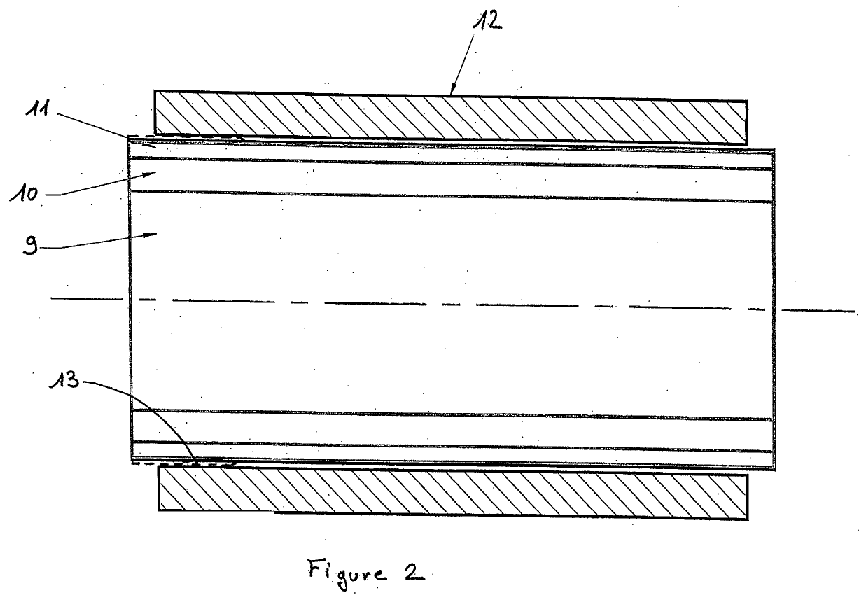

FIG. 2 shows an embodiment of the invention wherein the bladder consists of at least two layers forming two casings, the first one 9 being contained in the second one 11. The outer surface of casing 11 carries the structured surfaces allowing the impressions to be formed on the inner surface of tube 12.

Pressurization of bladder 9 allows to feed it into the tube, second casing 11 being retracted on the first bladder so as to prevent contact friction against the paint coat. Once in place, second bladder 11 is pressurized to be applied against the wall of the tube. For the application to be regular, the clearance between the double casings is selected small enough for the contact zone to move longitudinally as shown in zone 13 upon pressurization at one end thereof. This condition notably allows to avoid trapping air bubbles during impression.

To facilitate introduction of the device in the tube, a third casing 10 can be inserted between outer bladder 11 and inner bladder 9. This third casing is pressurized only after introduction of all of the bladders in the tube. Thus, the device can have a smaller outside diameter, which facilitates setting thereof in tubes of great length. Once the intermediate casing pressurized, the diameter increase allows the outer bladder to correctly fulfil its function, which requires a small-scale diameter variation or expansion.

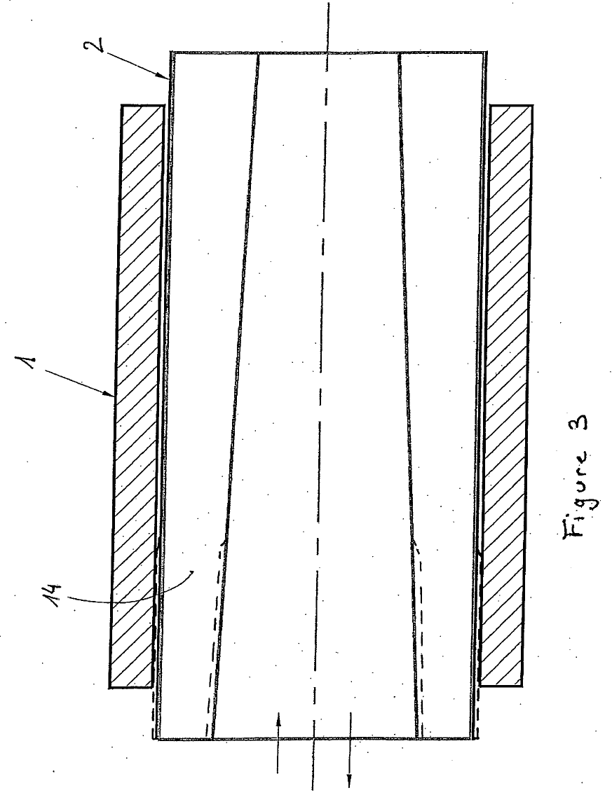

FIG. 3 shows another variant of the structured surface impression device wherein the bladder has a wall 14 of increasing thickness between the two ends. As above, the outer surface of the casing of the bladder bears the structured surfaces, either directly impressed or by sticking films bearing the structured surfaces.

Once the bladder fed into the tube, the internal pressure of the bladder is increased as a function of time. Thus, when the deformation pressure corresponding to the thickness of the wall is reached, the outer surface comes into contact with the coated surface of the tube. Since the thickness of the wall increases regularly from one end of the device to the other, as a function of time, contact is also achieved regularly from one end of the tube to the other.

Once impressed, the bladder is depressurized, possibly placed under vacuum, to unstick the surface from the tube wall.

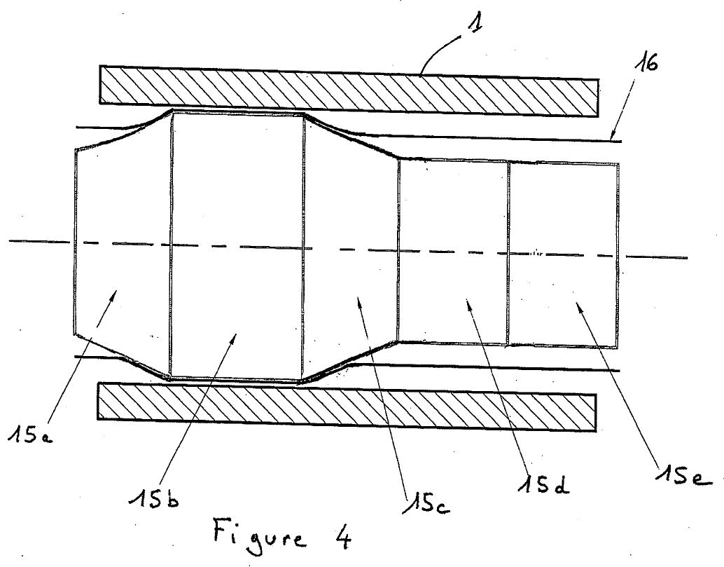

FIG. 4 shows another embodiment wherein the device consists of a longitudinal assembly of several bladders 15a, 15b, 15c, 15d, 15e, forming expansion means for a tubular casing 16 comprising the structured surfaces.

As shown in FIG. 4, inflation of a bladder 15b presses film 16 over a length corresponding to the width of the bladder. When the pressing time is over, neighbouring bladder 15c is inflated prior to deflation of bladder 15b. The procedure is continued so that film 16 is entirely pressed against the surface while keeping always at least one bladder inflated. Thus, application of the contact pressure is more easily controlled by means of the smaller and independent volume between each bladder.

According to this variant, it is possible to keep for some time all of the bladders under pressure, or to inflate then deflate the bladders successively, one after the other.

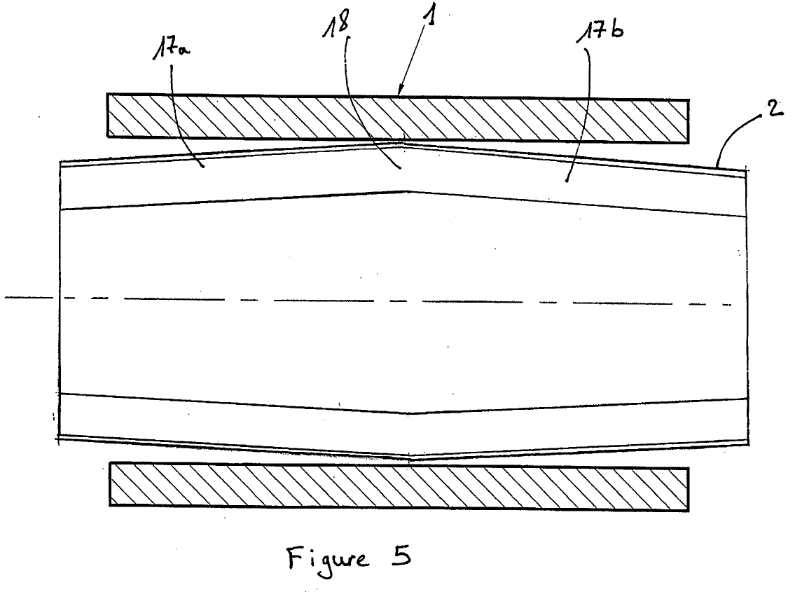

FIG. 5 describes a variant wherein the bladder has a wall of constant thickness bearing, on the outer surfaces thereof, structured surfaces 2. In this variant, the bladder has a two-cone 17a and 17b geometry, the bases being joined so as to form a preferred inflation zone 18. Thus, upon pressurization, the first contact of structured surfaces 2 occurs in line with zone 18, with an angle that notably depends on the angle of the cones.

1. A method for making structured surfaces on the inner wall of a pipe provided with a coating during baking and/or drying, characterized in that expandable means comprising structurations on the outer surface thereof are arranged inside said pipe, said expandable means are expanded so as to impress said structurations on the coated inner wall, baking and/or drying of the thus irreversibly deformed coating are finalized.

2. A method as claimed in claim 1, wherein the expandable means comprise a bladder, the structurations being either made directly on the casing of said bladder or on a film placed on the bladder.

3. A method as claimed in claim 1, wherein the expandable means include a ring-shaped part so as to press the outer surface of the expandable means onto the coating, and said part can be moved longitudinally over the length of the tube.

4. A method as claimed in claim 1, wherein the expandable means include a bladder having at least a double casing, the first casing being pressurized as it is fed into the pipe, the second one comprising the structurations on the outer surface thereof being pressurized from one of its ends to obtain even application from this end.

5. A method as claimed in claim 4, wherein the annular space of the second casing is reduced using an intermediate bladder casing that is pressurized after setting in the tube and before pressurization of said second casing.

6. A method as claimed in claim 1, wherein the expandable means include a bladder with a wall of increasing thickness between the two ends, and wherein contacting for impression is obtained as a result of an internal pressure increase as a function of time.

7. A method as claimed in claim 1, wherein the expandable means include a bladder with a constant-thickness wall comprising a preferred deformation zone that is first contacted for impression, as a result of an internal pressure increase as a function of time.

8. A method as claimed in claim 1, wherein the expandable means include a set of bladders arranged longitudinally along the axis of the tube, and wherein said bladders are pressurized successively one after the other.

9. A method as claimed in claim 8, wherein a bladder is deflated only after inflation of the next one.

10. A device for making structured surfaces on the inner wall of a pipe provided with a coating during baking and/or drying, characterized in that it comprises expandable means including on the outer surface thereof structurations and means for expanding said expandable means so as to impress said structurations on the coated inner wall.

11. A device as claimed in claim 10, wherein the expandable means comprise a bladder, the structurations being made either directly on the casing of said bladder or on a film placed on the bladder.

12. A device as claimed in claim 10, wherein the expandable means include a ring-shaped part so as to press the outer surface of the expandable means onto the coating, and means intended for longitudinal displacement of said part over the length of the tube.

13. A device as claimed in claim 10, wherein the expandable means include a bladder having at least a double casing, the first casing being suited to be pressurized in order to be fed into the pipe, the second one comprising the structurations on the outer surface thereof having a small annular space with the first casing and being suited to be pressurized from one of its ends to obtain even impression from this end.

14. A device as claimed in claim 13, wherein an intermediate bladder casing between the first and the second one is suited to be pressurized after setting in the tube and before pressurization of said second casing, so as to reduce the annular space of the second casing.

15. A device as claimed in claim 10, wherein the expandable means include a bladder with a wall of increasing thickness between the two ends, suited to be pressurized according to an internal pressure increase as a function of time.

16. A device as claimed in claim 10, wherein the expandable means include a set of bladders arranged longitudinally along the axis of the tube and interior to a casing bearing the structurations, and suited to be successively pressurized.

17. A device as claimed in claim 10, wherein the expandable means include a bladder with a constant-thickness wall whose shape is a double cone assembled at the bases thereof.
